(19) United States
(12) Patent Application Publication
(10) Pub. No.: US 2023/0341309 A1
(43) Pub. Date: Oct. 26, 2023

(54) DEVICE AND METHOD TO DETERMINE THE VISCOSITY OR VISCOELASTICITY OF A LIQUID FROM THE TORQUE OF A RIMMING FLOW

(71) Applicant: Jurgen Sanders, Vila Nova de Gaia (PT)

(72) Inventor: Jurgen Sanders, Vila Nova de Gaia (PT)

(21) Appl. No.: 18/295,434

(22) Filed: Apr. 4, 2023

(30) Foreign Application Priority Data
Apr. 21, 2022 (PT) 20221000001714

(51) Int. Cl. G01N 11/14; G01B 11/06

(52) U.S. Cl. CPC G01N 11/14; G01B 11/06

(57) ABSTRACT

The invention discloses a device for viscosity or viscoelasticity measurement comprising: a horizontal rotatable cylinder-shaped section for receiving a liquid whose viscosity or viscoelasticity is to be measured, and a torque meter for measuring the torque from said liquid while in rotation. It also discloses a method of measuring viscosity or viscoelasticity of a liquid comprising the following steps: placing a liquid into a horizontal rotatable cylinder-shaped section, said liquid partially filling said structure; rotating said structure at a speed such that a quasi-cylindrical inner free surface of the liquid is obtained; determining the torque from said liquid when rotating said partially filled structure and calculating the viscosity or viscoelasticity of the liquid from the torque determined in the previous step.

### FIELD OF THE INVENTION

The invention describes a device and method for measuring viscoelastic properties of liquids and relates to the field of rheometry, in particular to the field of fluid mechanics.

Viscoelastic liquids are characterized by their viscous and elastic properties. Typically, these properties depend on the speed or frequency of excitation and they vary with temperature. An example of a viscoelastic liquid may be a thick polymer solution, where long polymer chains induce a certain amount of elasticity while the solvent assures that the solution can flow like a liquid. In fast motions, or at higher frequencies, the elastic properties dominate the response, while in slow motions, or at lower frequencies, the viscous properties dominate.

### BACKGROUND OF THE INVENTION

Viscoelastic properties of a given material can be observed, in principle, by any imposed movement on a sample.

In the art, it is most common to determine the viscoelastic properties of a material sample by measuring the relaxation response after a sudden step-motion or by means of the amplitude and phase response to an imposed mechanical oscillation.

It is also common to measure the amplitude and phase of the oscillating torque in an oscillating cone and plate viscometer, also called “rheometer”. The amplitude and phase measurements determine material parameters which can be represented in the linear range for liquids by the so-called “complex viscosity”. Normally, the complex viscosity varies with the frequency of excitation and with temperature.

The complex notation is customarily used for convenience. Really, the complex viscosity has two distinct values η*=η′−iη″. Sometimes the real part of the complex viscosity is also called “dynamic viscosity”, while the imaginary part is called the “elastic part” [3]. Both, the dynamic viscosity and the elastic part change with the frequency of excitation. The common viscosity of so-called Newtonian liquids is a real valued constant. It is a special case of the complex viscosity for those liquids where η*=η is a dynamic viscosity that is constant and the elastic part is zero.

Cone and plate viscometers need very small liquid samples, usually a few drops, offer a wide range of measurement frequencies, and a straightforward theoretical interpretation.

Some disadvantages of cone and plate viscometers are the requirement for sensitive oscillating torque measurements, friction of the mechanical bearings, uncertain flow conditions at the outer edge of the cone and plate, the need for a precise adjustment of the gap width between the cone and the plate, difficult temperature control, and flow instabilities especially for larger gap widths and for liquids containing material impurities.

More relevant to the proposed invention is the determination of the same viscoelastic properties from measuring the free surface shape of rimming flow of a liquid inside a horizontal rotating cylinder. This was demonstrated 1981 in theory and by measurements [1]. At that time, the shape of the liquid free surface was determined from the light absorbed by the liquid between the inner and outer liquid surface. The light was passed from within the cylinder onto a photodiode glued on the outside of a transparent horizontal rotatable cylinder. The measurement resulted from the thickness of the liquid over the circumference of the cylinder.

In [1], for preparing the measurement, the cylinder was first rotated at a very fast rotation such that centrifugal force dominates, pressing the liquid from the inside onto the cylinder walls at uniform thickness in a near rigid motion. Then, at subsequently reduced lower rotational speed the liquid gets affected by gravity, letting it flow relative to the rotational direction of the cylinder. This is also called “rimming flow”. Phase and amplitude of this flow, or of the resulting thickness of the liquid as a function of the rotational angle, allow determining the viscoelastic properties and the complex viscosity.

In Sanders et al. [1], the rotatable cylinder was 60.5 cm long with an inner diameter of 6.45 cm, liquid thickness was up to 2 cm, rotation speeds were from 0.25 to 10 rotations per second, and the liquids tested had shear viscosities between 12 to 20 Pa s. The present invention developed a very different device as it is herein disclosed.

Measuring the liquid thickness around the circumference near the middle of the rotating horizontal cylinder by the light absorbed from the liquid can deliver very accurate results. But this method of measuring viscoelastic properties in rimming flow was not pursued further, probably because of a number of drawbacks limiting its practicality. Some of these drawbacks were the need for adding paint pigments to the liquid to make it light absorbing; the need for calibrating the light absorption coefficient; the difficulty of passing the electrical signal from the rotating photodiode; the need to bring the light source physically inside the horizontal rotating cylinder, and for the latter reason the difficulty for controlling the temperature.

An optical technique based on the reflection of light from the liquid surface was introduced in a recent patent application [2]. It determines the shape of the free surface in rimming flow by a light from one end of the cylinder to a focusing screen at the other, tracing the shape of the free surface. The advantage of this method is the possibility to encapsulate the cylinder with the liquid sample for better controlling the temperature.

As a matter of physics, it is relevant to this invention that the torque applied for rotating the liquid is directly related to the viscous dissipation within said liquid. Viscous dissipation is the heat produced within the liquid due to internal friction from the flow. This internal friction can be calculated directly from the flow field and is thus directly related to the complex viscosity at the respective frequency as given by the rotation speed. The application of this principle to rimming flow is new, and yet it is basic to the proposed invention.

The relation between torque and dissipation is used in a similar way by astronomers when explaining why the earth earth's rotation slows down over time due gravity of the moon and energy dissipation from tidal friction.

### General Description

The proposed invention refers to a mechanical device applied to rimming flow of viscoelastic liquids inside a horizontal rotating cylinder for determining viscoelastic properties of the liquid.

The invention proposes a mechanical device for measuring the dissipation of a liquid in rimming flow inside a horizontal rotatable cylinder by the torque applied for rotating said cylinder. The measurement allows determining the viscoelastic properties of the liquid.

Viscoelastic liquids are a common form of non-Newtonian liquids. They can exhibit a response that resembles that of an elastic solid under some circumstances, or the response of a viscous liquid under other circumstances. Typically, liquids that exhibit this behaviour are macromolecular in nature (that is, they have high molecular weight), such as polymeric liquids (melts and solutions) used to make plastic articles, food systems such as dough used to make bread and pasta, cosmetic liquids like shower gels, and biological liquids such as synovial liquids found in joints, and lubricants.

The macromolecular nature of polymeric molecules along with physical interactions called entanglements lead to the elastic behaviour (the liquids resemble a mass of live worms). Deformed molecules are driven by thermal motions to return to their undeformed states, giving the bulk fluid elastic recovery. Properties of polymeric fluids have a direct influence on the processing behaviour and in some cases on the performance of the polymer in a given application.

An example of a viscoelastic liquid may be a polymer solution where long polymer chains induce a certain amount of elasticity while the solvent assures that the solution can flow like a liquid. In fast motions, or at higher frequencies, the elastic properties dominate, while in slow motions, or at lower frequencies, the viscous properties dominate. Both, the amount of viscosity and the amount of elasticity are not constant values, but depend on the frequency of excitation. This is why, for a given liquid, and at otherwise constant conditions, the characterizing “complex viscosity” is not a constant value, but can be represented as two separate functions of the excitation frequency. In the embodiment of this disclosure, the excitation frequency is given by the action of gravity on the rotating liquid particle, gravity acting on each liquid particle at the frequency given by the rotation speed of the horizontal rotating cylinder. Measurements are normally taken over a range of excitation frequencies or, in an embodiment of this disclosure, over a range of rotation speeds.

The viscoelastic properties of a liquid depend on the speed of excitation. An example of a viscoelastic liquid may be a polymer solution, where long polymer chains induce a certain amount of elasticity while the solvent assures that the solution can flow like a liquid. In fast motions, or at higher frequencies, the elastic properties dominate, while in slow motions, or at lower frequencies, the viscous properties dominate.

In an embodiment, in rimming flow of viscoelastic liquids inside of a horizontal rotatable cylinder, the excitation comes from gravity and the frequency is imposed by the rotational speed. With decreasing rotation speed, gravity moves the liquid relative to the cylinder wall causing it to oscillate relative to the cylinder walls. This is also seen as an increased oscillation relative to the motion described by a rigid rotation. The dissipation caused by this oscillation can be measured by the torque that is applied to rotate said cylinder.

In an embodiment, the method of measurement comprises taking measurements for different levels of filling—different amounts of said viscoelastic liquid filling said cylinder—or different diameters or different length of said cylinder at the same rotating speed.

Advantages of measuring viscoelasticity in a horizontal rotatable cylinder are: increasing the measurement accuracy, measuring a wider range of possible liquids, obtaining a better temperature control, using larger liquid samples, and under certain conditions it may be possible to achieve higher measurement sensitivities.

Additional advantages of the present disclosure based on measuring torque are a very robust equipment, a possible complete enclosure of the liquid, possible use of ball bearing or air bearings, and a larger range of possible operating temperatures.

An additional advantage is the ease of combining the means for torque measurement with other parameter measurements. In an embodiment, such other measurements are temperature measurements or measurements of the liquid thickness by optical means as shown in FIG. 3. An optical method for measuring the liquid thickness is described by Sanders et. al in [1]. Such a combination of measurement methods allows studying the flow field in more detail and verifying different evaluation models.

An additional advantage is also the possibility of measuring a wider range of liquids, including also liquids that are not transparent, liquids that do not reflect light on their free surface, foaming liquids, mixtures of liquids, liquids with impurities, liquids that contain particles, liquids that contain heavy spheres, or combinations thereof.

In an embodiment, the cylinder rotates around its horizontal length axis at sufficient speed such that the liquid adheres to the inner wall of the cylinder forming a circular or near-circular inner free surface leaving a sufficiently wide annular open space around the rotation axis of the cylinder.

A particularly preferred embodiment of the present invention is a device for viscosity or viscoelasticity measurement, as shown in FIG. 2, comprising:
a structure comprising a horizontal rotatable cylinder-shaped section for receiving a liquid whose viscosity or viscoelasticity is to be measured;
means for measuring the applied torque;
an electric motor or other fixture suitable for rotating said horizontal rotatable cylinder at desired rotation speeds;
an electronic data processor arranged for calculating the viscosity or viscoelasticity of the liquid from the measured torque at one or more than one geometrical configuration at a given rotation speed.

The complex viscosity is related to the measured torque in many ways. In an embodiment, the device of the present disclosure is calibrated with liquids of known properties.

In the context of the present invention, it is important to relate the dissipation power P to the calculated flow field and the resulting extra stresses. The dissipation power in the liquid is P=∫_{V} tr[SV̅v^{T}]dv, where the linear terms for the extra stress tensor S and the gradient of the velocity field v are given, for example in [1]. Both terms depend directly on the complex viscosity η*(Ω) Computing the integral over the liquid volume V and the trace is basic and can be performed with a PC. The dissipation power P relates to the torque τ at a given rotation speed Ω by P=τΩ. Obtaining the two values of the complex viscosity η′ and η″(η*=η−iη″) is possible by measuring at two different filling levels at the same rotation speed Ω. Accounting for the effect of the end-pieces of said cylinder can be done by measuring in two cylinders of same diameter, but different length.

In an embodiment, the means for determining the torque from a liquid depend on the technical suitability for a particular installation. In an embodiment, a torque meter is placed directly at a motor or on the driving axis between a motor and said cylinder.

In an embodiment, other ways of determining the torque are part of the scope of the present disclosure, as they are functionally equivalent to a torque meter. For example, the torque from a liquid can be deduced from the electrical power supplied to the motor or the torque can be deduced from the speed run-off curve from a free spinning structure.

The present invention also discloses a method of calibrating the device herein disclosed directly to a readout of viscoelastic parameters without explicitly mentioning the measured torque.

In a particular embodiment, the device of the present invention is open at one or both ends. This feature provides the advantage of being possible to observe the liquid, allows to add or subtract liquid from the content of the structure, to add chemicals or other substances, to change environmental conditions like atmosphere conditions or temperature, to add means of measuring the temperature, or to add other means for measurement of the liquid thickness.

In an embodiment, the present invention discloses a device for viscosity or viscoelasticity measurement of a liquid comprising:
a structure comprising a horizontal rotatable cylinder-shaped section for receiving a liquid whose viscosity or viscoelasticity is to be measured;
a transducer, particularly a torque meter, an electric motor or any other means for measuring the torque from a liquid, for measuring the torque from said liquid and for producing an output signal based on the torque measurement or from;
wherein said torque measurement is dependent on the rotation speed of said structure.

In an embodiment, the present invention discloses a device further comprising a liquid whose viscosity or viscoelasticity is to be measured and air, a second fluid, a floating material and/or a rigid float.

In an embodiment, the present invention discloses a device wherein the liquid is in the flow regime of rimming flow.

In an embodiment, the present invention discloses a device having means for controlling rotation speed.

In an embodiment, the present invention discloses a device wherein the structure is partially open at one or both ends.

In an embodiment, the present invention discloses a device wherein the structure has a variable diameter, in particular the structure is tapered towards one or both ends.

In an embodiment, the present invention discloses a device wherein said structure comprises an inner surface having an antioxidant and/or antimicrobial coating.

In an embodiment, the present invention discloses a device wherein said structure is made of polymethyl methacrylate, ceramics, glass, hard plastic, steel or combinations thereof.

In an embodiment, the present invention discloses a device wherein said structure has an inner diameter from 60 mm to 300 mm, preferably from 64 mm to 200 mm, particularly 120 mm.

In an embodiment, the present invention discloses a device wherein said structure has a length from 150 to 1000 mm, preferably from 200 mm to 600 mm, particularly 300 mm.

In an embodiment, the present invention discloses a device further comprising an outer case around the horizontal rotatable cylinder for monitoring the temperature during viscosity or viscoelasticity measurement.

In an embodiment, the present invention discloses a device wherein the structure comprises at least one ball bearing or at least one air bearing.

In an embodiment, the present invention discloses a device further comprising means for determining the weight of the liquid while it is inside of said structure.

In an embodiment, the present invention discloses a device further comprising means for measuring the thickness of said liquid, wherein said means are optical means.

In an embodiment, the present invention discloses a device comprising a light source in a position in the central area of the horizontal rotatable cylinder.

In a further embodiment the present invention discloses a method of manufacturing or assembling a device according to any of the previous claims.

In a further embodiment the present invention discloses a method of measuring viscosity or viscoelasticity of a liquid comprising the following steps:
placing a liquid into a structure comprising a horizontal rotatable cylinder-shaped section, said liquid partially filling said structure;
rotating said structure at a speed such that a quasi-cylindrical surface of the liquid is obtained;
determining the torque from said liquid when rotating said partially filled structure with a torque meter or an electric motor or any other means for measuring the torque from a liquid;
wherein the quasi-cylindrical surface of the said liquid is kept;
and calculating the viscosity or viscoelasticity of the liquid from the torque determined in the previous step.

In a further embodiment, the method of the present disclosure further comprises the step of:

repeating such measurement for said speed with different levels of filling and/or different diameters of said cylinder and/or different lengths of said structure to obtain additional data about the viscoelastic parameters or to increase the precision of the structure.

In a further embodiment, the present invention discloses a method wherein calculating the viscosity or viscoelasticity is performed on an electronic data processor.

In a further embodiment, the present invention discloses a method wherein the liquid is selected from the following list: liquid with no impurities, liquid with impurities, untransparent liquid, non-reflecting liquid, liquid with inhomogeneities, liquid with dirt particles, liquid with metal spheres or balls, liquid with foam, liquid with nanoparticles and mixtures thereof.

In a further embodiment, the present invention discloses a method wherein the speed is from 40 rpm to 1800 rpm, preferably 60 rpm-1200 rpm, even more preferably 120 rpm-300 rpm.

In a further embodiment, the present invention discloses a method wherein the liquid is in the flow regime of rimming flow.

In a further embodiment, the present invention discloses a method for calibrating the device of the present invention directly to a readout of viscoelastic parameters without the measured torque.

In a further embodiment, the present invention discloses the use of the device for assessing the dissipation of the liquid in said structure when said liquid is in the flow regime of rimming flow.

### BRIEF DESCRIPTION OF DRAWINGS

The following figures provide particular embodiments of the present invention and shall not be interpreted as limiting the scope of the disclosure.

FIG. 1 represents an embodiment of the present invention. Rimming flow occurs when the horizontal rotatable cylinder 101 rotates sufficiently fast. The flow field of the liquid 102 is driven by the rotation of said cylinder and gravity g. In rimming flow, the free surface 103 of the liquid has the shape of a near circular tube around the axis of the cylinder.

FIG. 2 is a side view of the device in an embodiment with the rotatable horizontal cylinder 201 partially filled with the test liquid 202. The test liquid forms an inner free surface 203 due to the flow field induced by the rotation and the centrifugal force. In the embodiment shown the two end-pieces 204 and 205 are closed. The cylinder is driven by a motor 206 and the rotating torque from the liquid is measured by a torque meter 207. The torque meter can be mounted at either side of the motor.

FIG. 3 represents an embodiment of the present invention. Said device with the horizontal rotatable cylinder 301 is combined with an optical measurement of the thickness of the rotating liquid. The configuration is similar as in FIG. 2, but the left end-piece 305 is partially open. This allows placing a light source 308 in a position near the center of the horizontal rotatable cylinder 301. A light sensor 309 is rotated independently from said cylinder 301 and, together with the light source it is moved in the axial direction of said cylinder 301. The light absorbed by the liquid on its path through the liquid, from the light source to the sensor, is a measure of the liquid thickness at the respective position. In this embodiment, the cylinder 301 is transparent and the liquid absorbs a certain amount of light.

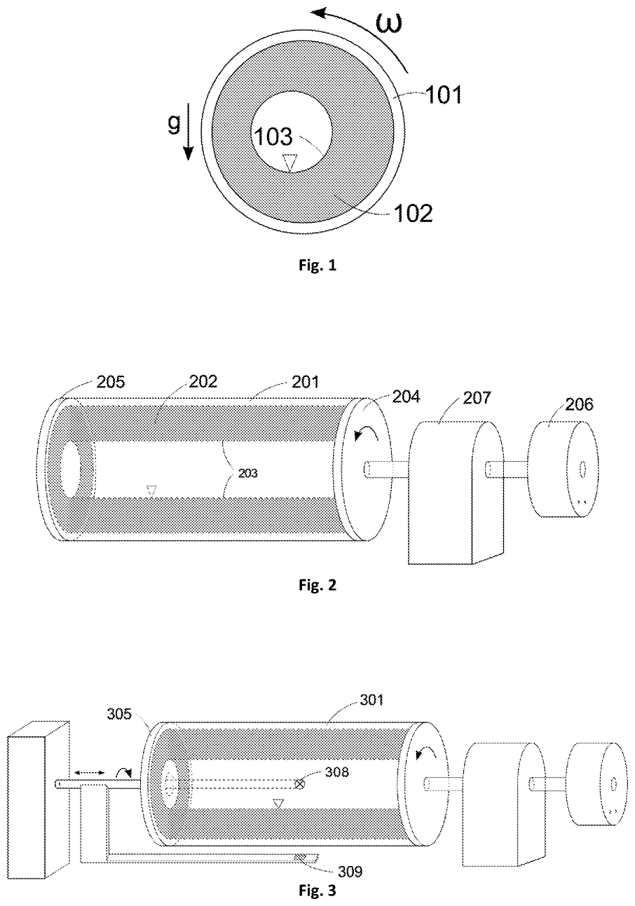

### DETAILED DESCRIPTION OF THE INVENTION

The proposed device is a horizontal rotatable cylinder with means for measuring the torque from a liquid, or that produces an output based on the torque, applied for rotating the said cylinder.

The cylinder is rotatable around its natural rotation axis.

In an embodiment the cylinder contains a liquid sample. The end pieces of the cylinder keep the liquid from flowing out of the cylinder when the cylinder rotates at sufficient speed. In an embodiment, the end pieces are completely closed or partially open.

In an embodiment, the liquid inside the device is in a quantity such that it fills the cylinder partially. The cylinder is rotatable at sufficient speed so that the liquid adheres to the inner wall of the cylinder, rotating with the cylinder and forming a circular or near-circular inner free surface leaving an annual open space around the rotation axis of the cylinder.

At high rotation speeds, from around 300 rpm, the liquid is in a near rigid rotation due the predominance of centrifugal forces. Measurements are performed at lower rotation speeds, when gravity affects the liquid flow and the torque applied for rotating the liquid has increased.

The algorithm for deducing the viscoelastic properties is based on a valid flow model that relates the viscoelastic properties to the rotation speed of the measurement and the measure torque.

In an embodiment, the device's performance is based on the measured torque or an equivalent to the torque without using the torque value itself, but calibrating the instrument directly for the viscoelastic parameters. This may be done for specific liquids by previous measurements or by measurements made with other type of instruments. The latter may be especially convenient when repeating measurements for the same liquid in a repetitive industrial application.

In a further embodiment, said cylinder is encapsulated in a heat shield. This would facilitate controlling the temperature of the measured liquid.

In a further embodiment, for liquids with uniform light absorption, said device comprises means for measuring the liquid thickness by the light shining through the liquid at different angles and different positions along the axis of the cylinder. The absorbed light is a measure of the thickness of the liquid layer at the respective position as shown in FIG. 3.

In a further embodiment, the proposed device measures viscoelastic properties of some other material, especially of liquid with no impurities, liquid with impurities, untransparent liquid, non-reflecting liquid, liquid with inhomogeneities, liquid with dirt particles, liquid with metal spheres or balls, liquid with foam, liquid with nanoparticles and mixtures thereof.

The meaning of “horizontal cylinder” is not restricted to the definition of a mathematical cylinder shape. It shall enclose any similar shape with the function as described for the cylinder above. In a particular embodiment, the horizontal cylinder is tapered towards its ends.

The meaning of “viscoelastic properties” comprises “viscosity” for Newtonian liquids as a special case.

The term “comprising” whenever used in this document is intended to indicate the presence of stated features, integers, steps, components, but not to preclude the presence or addition of one or more other features, integers, steps, components or groups thereof.

The disclosure is of course not in any way restricted to the embodiments described and a person with ordinary skill in the art will foresee many possibilities to modifications thereof without departing from the basic idea of the disclosure as defined in the appended claims.

The above-described embodiments are obviously combinable.

The following dependent claims set out particular embodiments of the disclosure.

### REFERENCES

[1] J. Sanders, D. D. Joseph and G. S. Beavers, Rimming Flow of a Viscoelastic Liquid Inside a Rotating Horizontal Cylinder, Journal of Non-Newtonian Fluid Mechanics, 9 (1981) 269-300.
[2] J. Sanders, “Device and method for viscosity or viscoelasticity measurement”, International patent application PCT/IB2020/061097.
[3] Ch. Macosko, “Rheology: Principles, Measurements and Applications”, Wiley-VCH, 1994.

1. Device for viscosity or viscoelasticity measurement of a liquid comprising:
a structure comprising a horizontal rotatable cylinder-shaped section for receiving a liquid whose viscosity or viscoelasticity is to be measured;
a transducer, particularly a torque meter, an electric motor or any other means for measuring the torque from said liquid and for producing an output signal based on the torque measurement;
wherein said torque measurement is dependent on the rotation speed of said structure.

2. Device according to claim 1, further comprising a liquid whose viscosity or viscoelasticity is to be measured and air, a second fluid, a floating material and/or a rigid float.

3. Device according to claim 1, wherein the liquid is in the flow regime of rimming flow.

4. Device according to claim 1, having means for controlling rotation speed.

5. Device according to claim 1, wherein the structure has a variable diameter, in particular the structure is tapered towards one or both ends, or where said structure is partially open at one or both ends.

6. Device according to claim 1, wherein said structure is made of polymethyl methacrylate, ceramics, glass, hard plastic, steel or combinations thereof, or wherein said structure comprises an inner surface having an antioxidant and/or antimicrobial coating.

7. Device according to claim 1, wherein said structure has an inner diameter from 60 mm to 300 mm, preferably from 64 mm to 200 mm, particularly 120 mm.

8. Device according to claim 1, wherein said structure has a length from 150 to 1000 mm, preferably from 200 mm to 600 mm, particularly 300 mm.

9. Device according to claim 1, further comprising an outer case around the horizontal rotatable cylinder for monitoring the temperature during viscosity or viscoelasticity measurement.

10. Device according to claim 1, wherein the structure comprises at least one ball bearing or at least one air bearing.

11. Device according to claim 1, further comprising means for determining the weight of the liquid while it is inside of said structure.

12. Device according to claim 1, further comprising means for measuring the thickness of said liquid, wherein said means are optical means which may comprise a light source in a position in the central area of the horizontal rotatable cylinder.

13. Method of measuring viscosity or viscoelasticity of a liquid comprising the following steps:
placing a liquid into a structure comprising a horizontal rotatable cylinder-shaped section, said liquid partially filling said structure;
rotating said structure at a speed such that a quasi-cylindrical free surface of the liquid is obtained;
determining the torque from said liquid when rotating said partially filled structure with a torque meter or an electric motor or any other means for measuring the torque from a liquid;
wherein the quasi-cylindrical free surface of the said liquid is kept;
and calculating the viscosity or viscoelasticity of the liquid from the torque determined in the previous step.

14. Method according to claim 13, comprising the steps of:
repeating such measurement for said speed with different levels of filling and/or different diameters of said cylinder and/or different lengths of said structure to obtain additional data about the viscoelastic parameters or to increase the precision of the structure.

15. Method according to claim 13 wherein the liquid is selected from the following list:
liquid with no impurities, liquid with impurities, untransparent liquid, non-reflecting liquid, liquid with inhomogeneities, liquid with dirt particles, liquid with metal spheres or balls, liquid with foam, liquid with nanoparticles and mixtures thereof.

16. Method according to claim 13 wherein the liquid is in the flow regime of rimming flow.
